(19) United States
(12) Patent Application Publication
(10) Pub. No.: US 2006/0125144 A1
(43) Pub. Date: Jun. 15, 2006

(54) Stent and stent manufacturing methods

(76) Inventors: Jan Weber, Maple Grove, MN (US); Thomas J. Holman, Minneapolis, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/011,483

(22) Filed: Dec. 14, 2004

(51) Int. Cl. B29C 41/08

(52) U.S. Cl. 264/309

(57) ABSTRACT

A stent is made by providing a sacrificial template which defines a stent pattern. At least one layer of material is applied over at least a portion of the stent pattern of the sacrificial template. The sacrificial template is then eliminated.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

This invention relates to medical devices for maintaining the patency of body passages. Medical devices such as stents, grafts, stent-grafts, vena cava filters, expandable frameworks and similar implantable medical devices, collectively referred to hereinafter as stents, are radially expandable endoprostheses which are typically intravascular implants capable of being implanted transluminally and enlarged radially after being introduced percutaneously. Stents may be implanted into a variety of body lumens or vessels such as within the vascular system, urinary tracts, bile ducts, etc. Stents may be used to reinforce body vessels and to prevent restenosis following angioplasty within the vascular system. They may be self-expanding, such as a nitinol shape memory stent, mechanically expandable, such as a balloon expandable stent, or hybrid expandable. Additionally, stents may serve as drug delivery vehicles.

All U.S. patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well only for the purposes of complying with 37 C.F.R. 1.72. The abstract is not intended to be used for interpreting the scope of the claims.

### BRIEF SUMMARY OF THE INVENTION

In accordance with the present invention, in at least one of its embodiments a stent manufactured utilizing a sacrificial structure or template is disclosed. The template defines a negative pattern stent upon which material is deposited to form a stent body. A stent manufactured in this manner is an expandable intraluminal stent comprising a main body portion having a first end, a second end and a flow passage defined therethrough, the main body portion being sized for intraluminal placement within a body passage and subsequent expansion for implantation.

By utilizing the sacrificial template a stent can be manufactured having any of a variety of characteristics. For example, in at least one embodiment of the invention a stent can be formed wherein when the stent is expanded a region of the body forms a bulge, crown, side branch opening, or similar structure(s) for deployment into or adjacent to a sidebranch vessel. In some embodiments the body of the stent may be provided with a continuous taper or be provided with one or more portions which taper to various degrees. In at least one embodiment a stent is formed having a branched structure such as may be used for the treatment of a vessel bifurcation.

In some embodiments, the stent is manufactured to have one or more pores suitable for the delivery of one or more therapeutic agents or drugs. In another embodiment the stent may be coated with a drug or drugs.

In various embodiments the stent may be manufactured of any suitable polymeric material deposited on the sacrificial pattern by any mechanism desired. Additional organic and/or inorganic components such as metal could be embedded within the polymer material. Such manufacturing mechanisms may include but are not limited to: spray coating, dipping, electrostatic deposition, etc. The stent can be manufactured using one or multiple layers of material. Some examples of materials suitable for use in forming the stent are described in further detail below. The thickness of any material(s) deposited on the sacrificial pattern and/or the number of material layers deposited may be varied to provide different regions of the stent with different characteristics as desired.

In some embodiments the material deposited on the pattern may include, embedded, encapsulated, or engaged thereto, one or more sensors (flow pressure, etc.), markers (detectable by imaging modalities such as X-Ray, MRI, ultrasound, etc.), marker bands, conductive coils, reinforcing fibers, etc.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described a embodiments of the invention.

### BRIEF DESCRIPTION OF THE SEVERAL VIEWS OF THE DRAWING(S)

A detailed description of the invention is hereafter described with specific reference being made to the drawings.

FIG. 1 is a perspective view of an embodiment of the invention comprising a sacrificial stent template.

FIG. 1a is a partial cut-away view of a portion of the template shown in FIG. 1

FIG. 2 is a partial cross-sectional view of a portion of the template shown in FIG. 1 having a suitable stent material applied to the template by spraying.

FIG. 3 is a perspective view of the embodiment shown in FIG. 1 having a suitable stent material applied to the template by dip coating.

FIG. 4 is a partial perspective view of an embodiment of the invention wherein the template shown in FIG. 1 is shown being removed from about the stent.

FIG. 5 is a partial perspective view of a stent manufactured in accordance with the steps illustrated in FIGS. 1-4.

FIGS. 6a-6c show a number of steps for the production of a stent in accordance with an embodiment of the invention.

FIG. 7 is a cross-sectional view of an embodiment of the invention showing the template of FIG. 1 with a plurality of material layers.

FIG. 8 is a side perspective view of an embodiment of the invention wherein the stent is configure to have a “bulged region” when expanded.

FIG. 9 is a longitudinal cross-sectional side view of an embodiment of the invention comprising a bifurcated stent assembly.

FIG. 10 is a longitudinal cross-sectional side view of an embodiment of the invention comprising a stent having a tapered region.

FIG. 11 is a cross-sectional end view of an embodiment of the invention comprising a stent equipped with enhancement devices.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

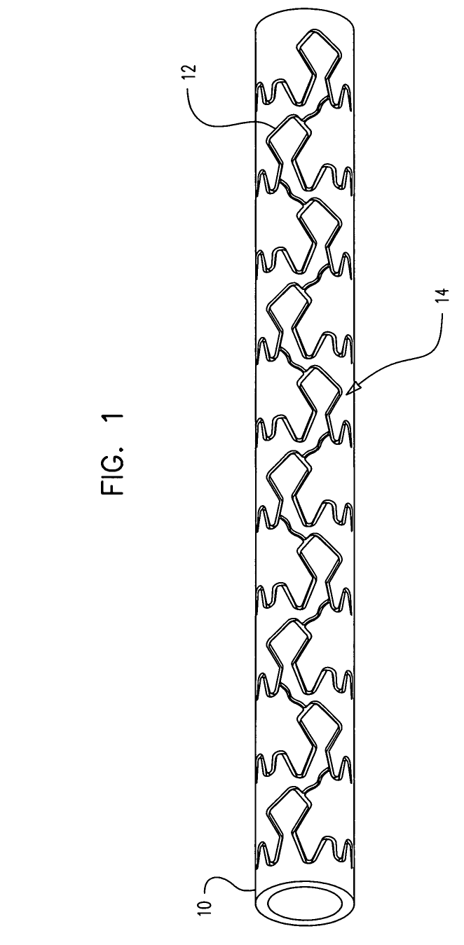

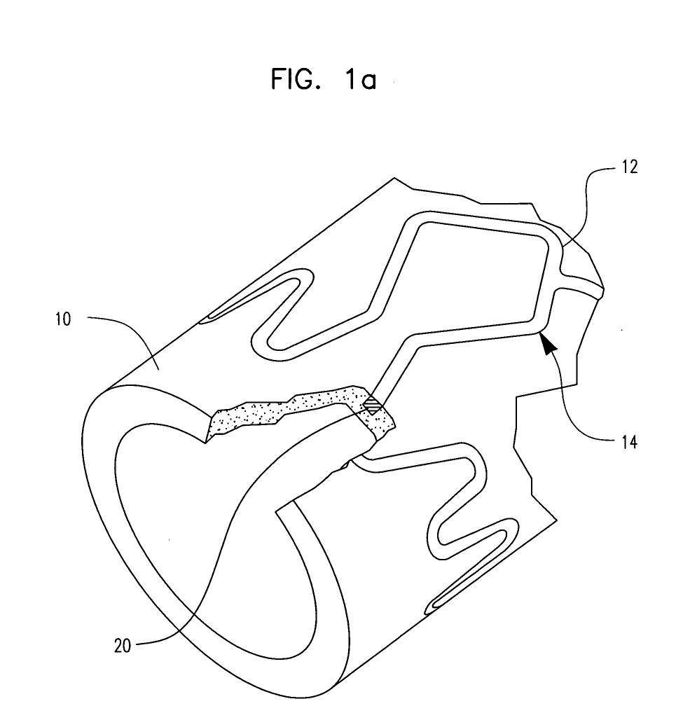

As indicated above the present invention relates to the formation of articles, particularly stents and/or portions thereof utilizing a sacrificial structure upon which the material of the eventual stent is deposited. For example, as illustrated in FIG. 1 a negative pattern stent form or template 10 is shown. The template 10 can be manufactured via any method or mechanism desired, such as by injection molding, extrusion followed by laser ablation, or any other method of prototyping. As is best shown in FIG. 1a, the template 10 may define one or more grooves or indentations 12 which form the negative stent pattern 14 desired.

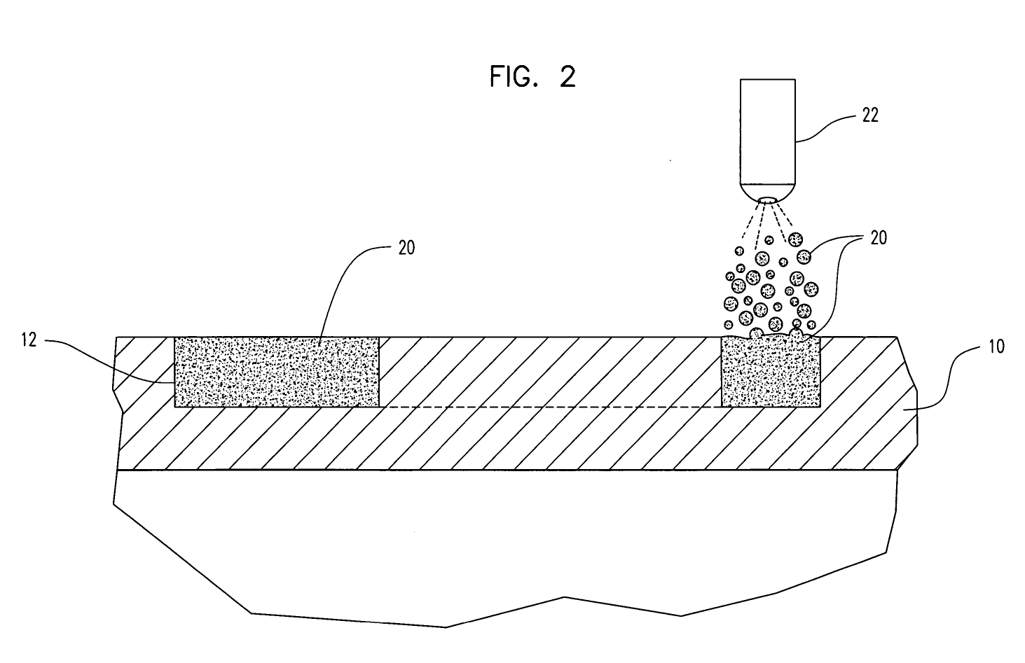

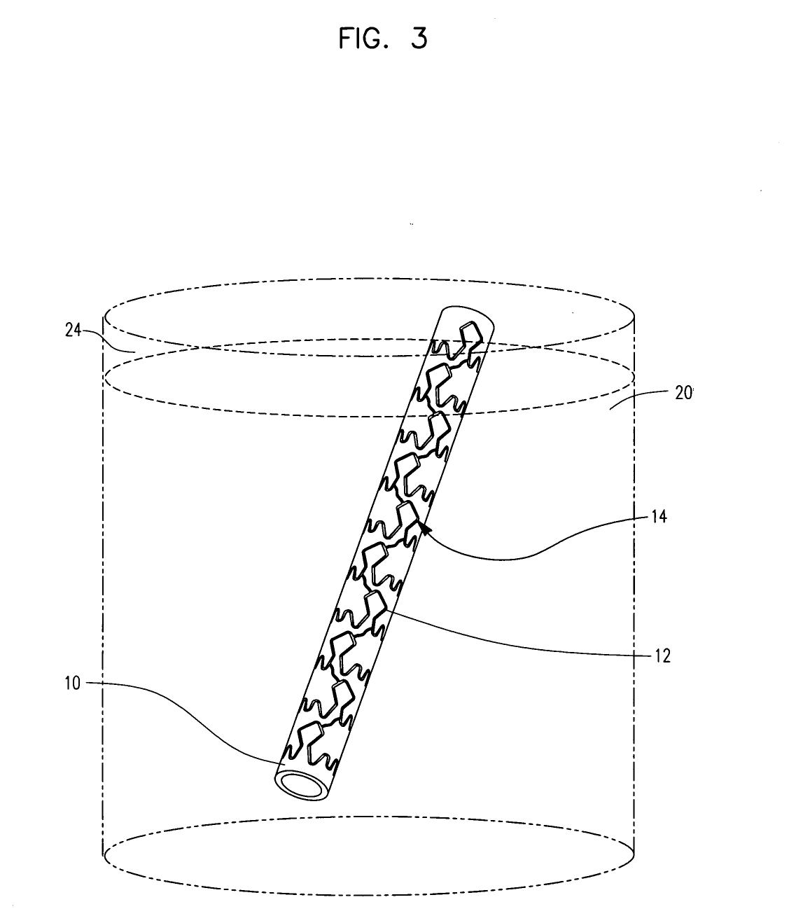

As shown in FIG. 1a, a suitable material 20 is deposited onto the template 10 and allowed to fill or build-up within the indentations 12 in accordance with the pattern 14 defined. As illustrated in FIG. 2 the material 20 can be deposited by spray coating from a suitable spraying mechanism, such as the spray head 22 shown. In some embodiments, such as is shown in FIG. 3, the template 10 can be dipped into a reservoir 24 of the material 20. These and other deposition processes may be utilized alone, or in combination, to place one or more layers of material 20 onto the pattern 14 of the template 10.

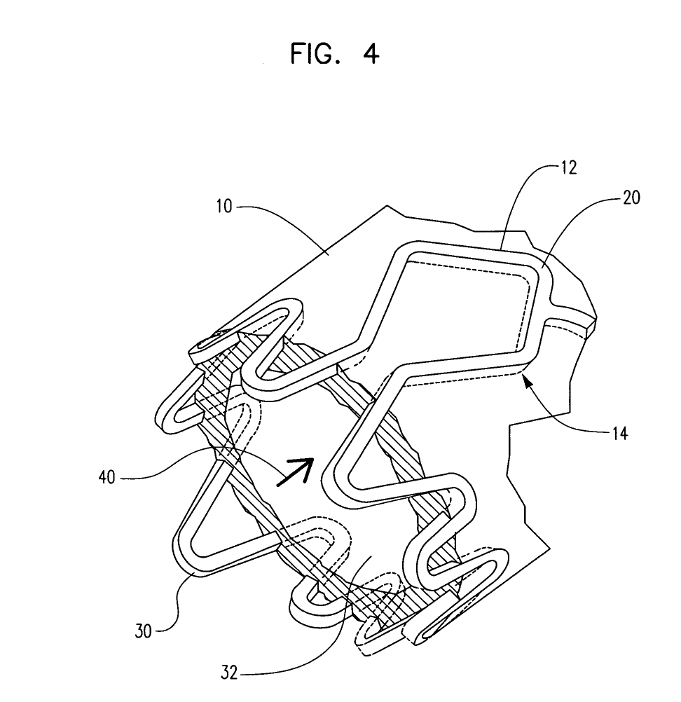

After the template 10 has been coated, sprayed, or otherwise had material 20 deposited thereon, the material 20 is cured. The cured form is processed to remove excess material 20 from the eventual stent form 30 such as is shown in FIG. 4. In at least one embodiment a tube or other member is closely fitted over the template 10 and material 20 is injection molded between to template and tube to form the stent.

The present invention may include any number of layers of material 20. The additional layers may be formed from any materials conventionally employed in the formation of stents and may include but are not limited to: thermoplastic polymers, thermosetting polymers, biodegradable polymeric materials, fibers, and so forth. Non-polymeric materials such as metal may also be employed. Any combination of different materials layers may also be utilized.

In at least one embodiment, material 20 comprises a silica based sol-gel. The sol-gel material 20 can further comprise additional substances such as conductive metal(s), dielectric materials (ceramics, polymers, filled polymers, etc.), one or more layers of magnetic material (metals and/or polymers filled with nanomagnetic particles, etc.) Using such materials allows layered electronic circuits to be built inside the strut element(s) of the stent. Such stents could be configured for electronic communication with external devices; be equipped with sensors that are in communication with one another or even between implant, etc. In the case of a drug eluting stent, the stent could be configured to electronically regulate the release of a drug therefrom.

As indicated above, the template 10 is a sacrificial structure, meaning that the template 10 is removed in whole or in part subsequent to the deposition of material 20 thereon. In this manner, once the desired quantity and/or number of layers of material 20 is applied to the template 10 to fill the indentations 12 of the pattern 14, the template 10 can be removed.

As used herein sacrificial materials suitable for use in the formation of the template 10 include those which may be eliminated from the resultant stent 30, as shown in FIG. 4 by melting, dissolution, and so forth. Dissolution does not require complete dissolution, but rather may involve partial dissolution sufficient for removal of the shape-form from the article.

Examples of sacrificial materials suitable for construction of the template 10 include, but are not limited to, ice, starch, sugar, waxes, solvatable polymeric materials including those which are dispersible or soluble in water such as polyvinyl alcohol (PVOH), polyvinyl acetate (PVA), and so forth. Specific PVA polymers may be purchased from Adept Polymers Limited, Unit 7, Woodrow Way, Fairhills Industrial Estate, Irlam, Manchester, M44 6ZQ under the name of Depart Products, W-50 product series. One such polymer has a melting temperature as measured by DSC of 206° C. Dissolution may be partial, providing that the material is reduced to a size which is small enough such as to be readily removable from the preform or stent structure. The template 10 may be removed from the stent 30 using any means suitable for the type of material from which it is formed. For example in the embodiment depicted in FIG. 4 a PVA template 10 is removed through the application of water (H₂O) or other fluid, indicated by arrow 40, through the flow path 32 of the template 10. Fluid 40 may be applied to the template 10 by way of a bath or spray. In at least one embodiment the stent 30 and/or fluid 40 is subjected to ultrasonic vibration to speed up the complete or temporary removal of the template 10. In at least one embodiment fluid 40 is applied to the template 10 a temperature of about 25° C. to about 110° C.

As indicated, in at least one embodiment some amount of template material may be allowed to remain in contact with the stent. Such a partial template may be suitable for use as a partial stent protector which may be completely removed prior to insertion of the stent into a body lumen. In some embodiments selectively layering materials 20 over and around the sacrificial material of the template 10, allows for the creation of hollow members once the stent 30 is fully formed and the surrounded sacrificial material is fully removed.

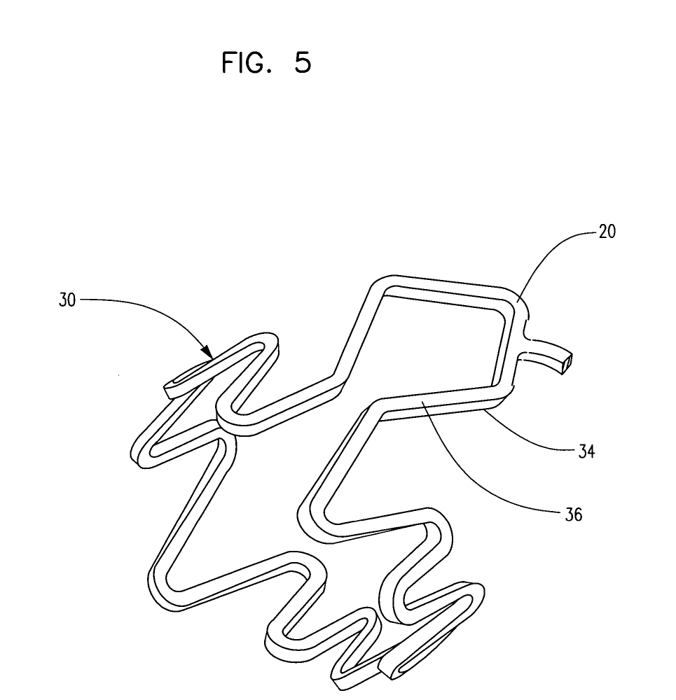

Once the material of the template is adequately removed, the material 20 is left completely exposed in the form of a stent 30, such as is shown in FIG. 5, in accordance with the pattern previously defined by the template. The resultant stent 30 defines a body 34 comprising a plurality of interconnecting stent members 36 which are arranged in accordance with the pattern of the template. As indicated above, the pattern may be any pattern desired, and therefore the arrangement of the members 36 may be likewise have any arrangement desired. Some examples of suitable arrangements of stent members are shown in U.S. Pat. No. 6,348,065

The material 20 from which the eventual stent 30 is formed be comprise any suitable thermoplastic and/or thermosetting material for formation of an expandable stent.

Some examples of suitable non-elastomeric materials include, but are not limited to, polyolefins including polyethylene and polypropylene, polyesters, polyethers, polyamides, polyurethanes, polyimides, and so forth, as well as copolymers and terpolymers thereof. As used herein, the term “copolymer” shall hereinafter be used to refer to any polymer formed from two or more monomers.

Some examples of suitable elastomeric materials include, but are not limited to, elastomeric block copolymers including the styrenic block copolymers such as styrene-ethylene/butylene-styrene (SEBS) block copolymers disclosed in U.S. Pat. No. 5,112,900 which is incorporated by reference herein in its entirety. Other suitable block copolymer elastomers include, but are not limited to, styrene-isoprene-styrene (SIS), styrene-butadiene-styrene (SBS), styrene-isobutylene-styrene (SIBS), styrene-ethylene/propylene-styrene (SEPS) and so forth. Block copolymer elastomers are also described in commonly assigned U.S. Pat. Nos. 6,406,457, 6,171,278, 6,146,356, 5,951,941, 5,830,182, 5,556,383, each of which is incorporated by reference herein in its entirety.

Elastomeric polyesters and copolyesters may be employed herein. Examples of elastomeric copolyesters include, but are not limited to, poly(ester-block ether) elastomers, poly(ester-block-ester) elastomers and so forth. Poly(ester-block-ether) elastomers are available under the tradename of HYTREL® from DuPont de Nemours & Co. and consist of hard segments of polybutylene terephthalate and soft segments based on long chain polyether glycols. Such polymers are also available from DSM Engineering Plastics under the tradename of ARNITEL®.

Non-elastomeric polyesters and copolymers thereof may be employed such as the polyalkylene naphthalates including polyethylene terephthalate and polybutylene terephthalate, for example.

Polyamides including nylon, and copolymers thereof may be employed herein. Block copolymer elastomers such as poly(ether-block-amides) may be employed herein and are available from Atofina Chemicals in Philadelphia, Pa., under the tradename of PEBAX®.

The above lists are intended for illustrative purposes only, and not as a limitation on the scope of the present invention. Other polymeric materials not described herein, may find utility in the formation of stents according to the invention.

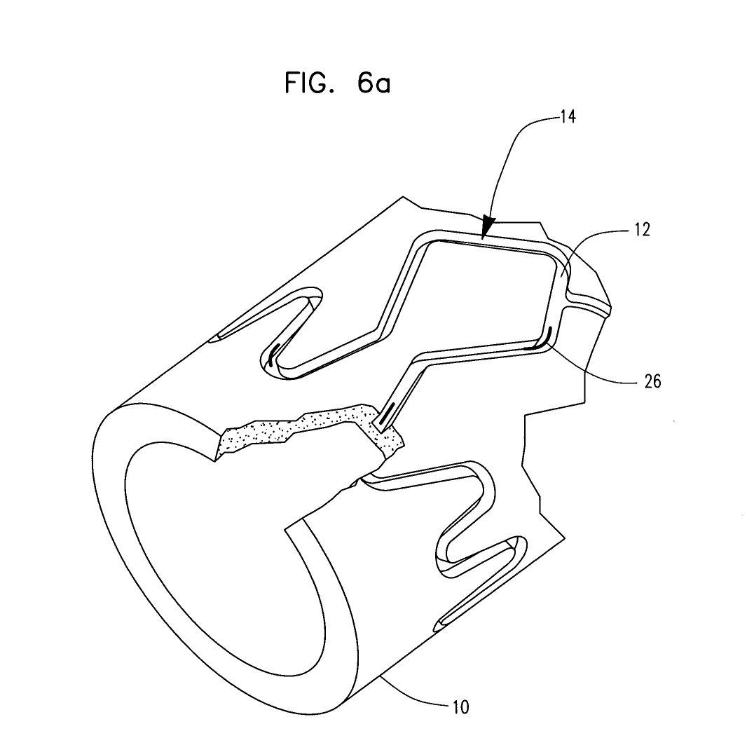

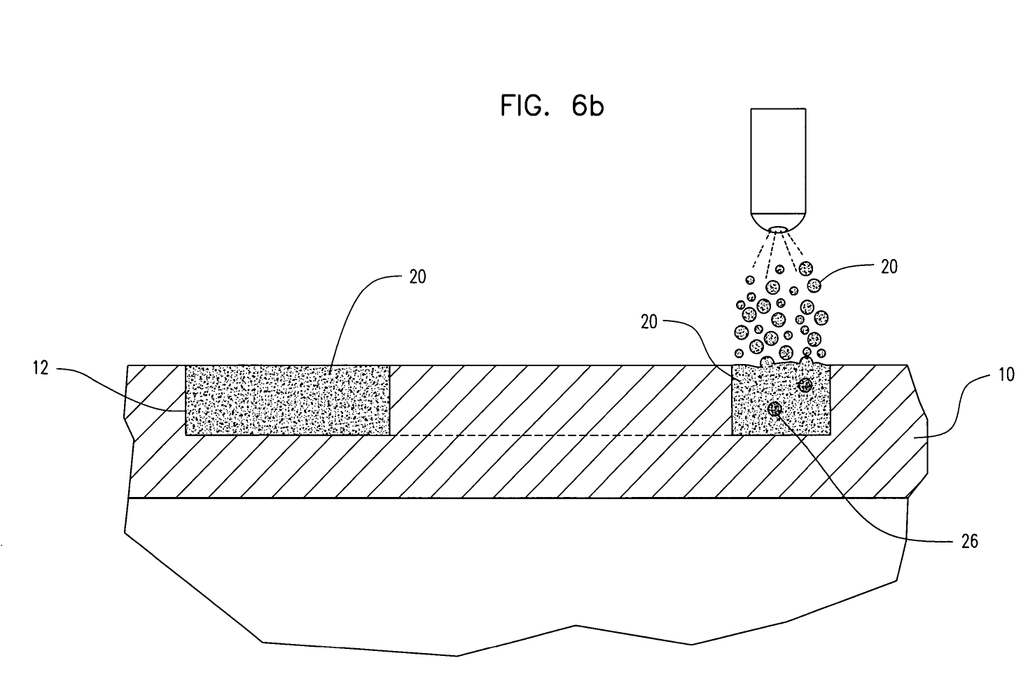

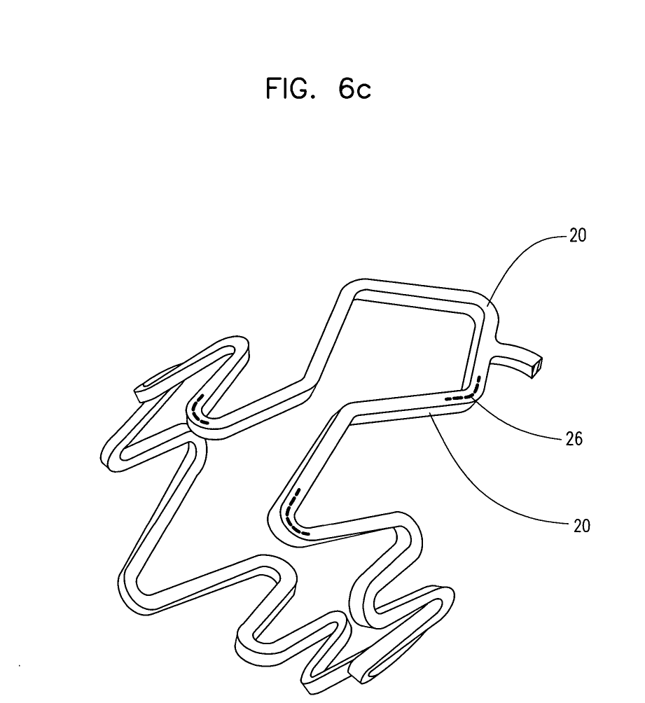

In at least one embodiment, such as is illustrated in FIG. 6D, the material 20 of the stent 30 may include one or more fibers 26. Fibers are thread-like materials which can be in the form of a monofilament, i.e. a single thread, or in multifilament forms, i.e. a yarn, and the present invention is not limited to any particular fiber form. For example, fibers may be in the form of a web, mat, yarn, braid, weave, rove, chopped, etc. The fibers may be positioned randomly, or may be positioned uniformly.

Suitable fibers for use herein include both synthetic and natural fibers. As used herein, natural fibers refer to those which occur in nature, i.e. those produced by members of the phylum Arthropoda including arachnids and insects such as spiders, silk worms, black flies, wasps, and lacewing flies.

Synthetic fibers refer to those fibers which are man-made such as synthetic polymeric fibers, and those produced using recombinant protein technology.

Examples of suitable synthetic high strength polymeric fiber materials include, but not limited to, such as poly-paraphenylene terephthalamide fibers available from DuPont de Nemours & Co. under the tradename of Kevlar®; liquid crystal polymer fibers such as those available from Celanese Chemicals in Dallas, Tex. under the tradename of Vectran®; ultra high strength polyethylene fibers such as those available from Honeywell International in Morristown, N.J. under the tradename of Spectra® and from Toyobo Co., Ltd. in Osaka, Japan under the tradename of Dyneema®; polyester fibers such as those available from Invista in Wichita, Kan. under the tradename of Dacron®; poly-(p-phenylenebenzobisthiazole)(PBT) fibers such as Terlon® (PBT), the “know-how” and the technical documentation for manufacturing which is offered by license from Russian Federation, 141009, Mytischi, Moscow Region, VNIIPV; rigid-rod chain molecules of poly(p-phenylene-2,6-benzobisoxazole)(PBO) available from Toyobo Co., Ltd. under the tradename of Zylon®, polyimide (PIM), etc.

The above lists are intended for illustrative purposes only, and not intended to limit the scope of the present invention.

Fibers are discussed in U.S. Pat. No. 6,746,425, the entire content of which is incorporated herein by reference.

The use of fibers is not limited to any particular embodiment, and may be employed in any of the embodiments disclosed herein.

Fibers, reinforcing material, or other structural components 26 may be applied to the indentations 12 of the pattern 14 at any time during the formation of the stent. For example, in the embodiment depicted in FIGS. 6a-6c the components 26 are applied to the pattern 14 of the template 10, before application of material(s) 20 so as to fully or partially embed the components 26 into the matrix of the material 20. As shown in FIG. 6a the components 26 can be positioned on the template 10 in any position or orientation desired. For example, in at least one embodiment component 26 can be a metal fiber, strand or braid of material which has a different bending angle than the angle defined by the pattern of the template 10. As such, the component 26 will impart to the final stent 30 a permanent stress within the corners or bends of the stent pattern as desired.

Prior to, during, or subsequent to the placement of components 26 material 20 is applied over and/or around the components 26 in any manner desired, such as for example by spray coating. Once the material 20 has cured or set the sacrificial template 10 is removed in the manner described above and the stent 30, such as is shown in FIG. 6c remains. The resulting stent 30 is provided with a hybrid structure of one or more materials 20 along with fibers or other components 26.

In at least one embodiment components such as fibers 26 are applied to the interior and/or exterior surface of the stent 30 after the stent has been formed and the template 10 removed.

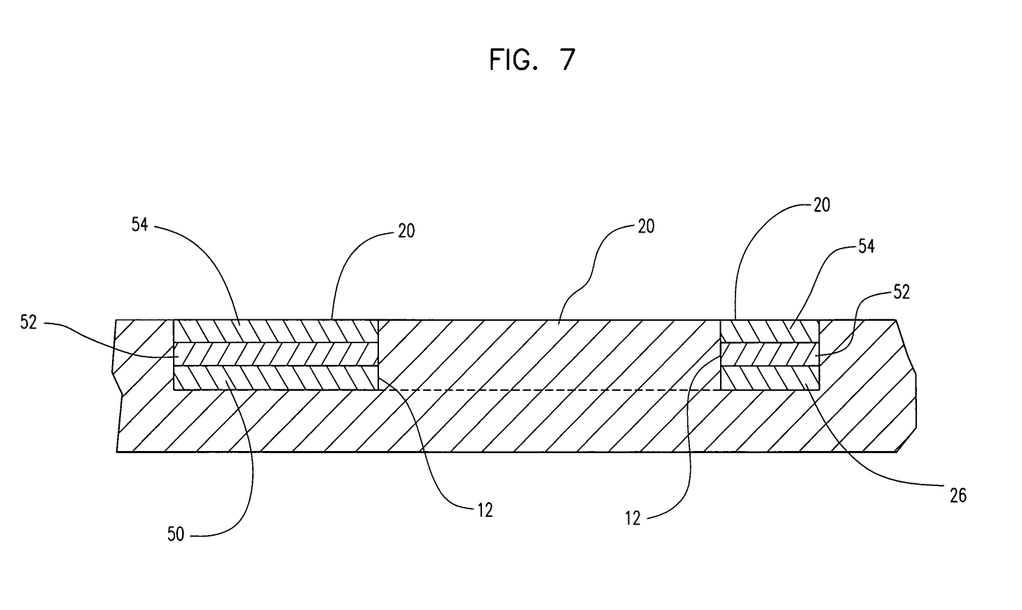

As indicated above multiple layers of similar or dissimilar material 20 may be applied to the template 10 to provide the stent pattern with a desired wall thickness or thicknesses. For example, in at least one embodiment, such as is shown in FIG. 7 a second layer 52 of material 20 may be deposited onto a first layer 50, and a third layer 54 deposited onto the second layer 52 and so forth to any desired thickness. Moreover, the application of multiple layers may be varied at different portions of the pattern. A given layer may also be selectively applied to provide a different thickness in different regions of the stent pattern as may be desired.

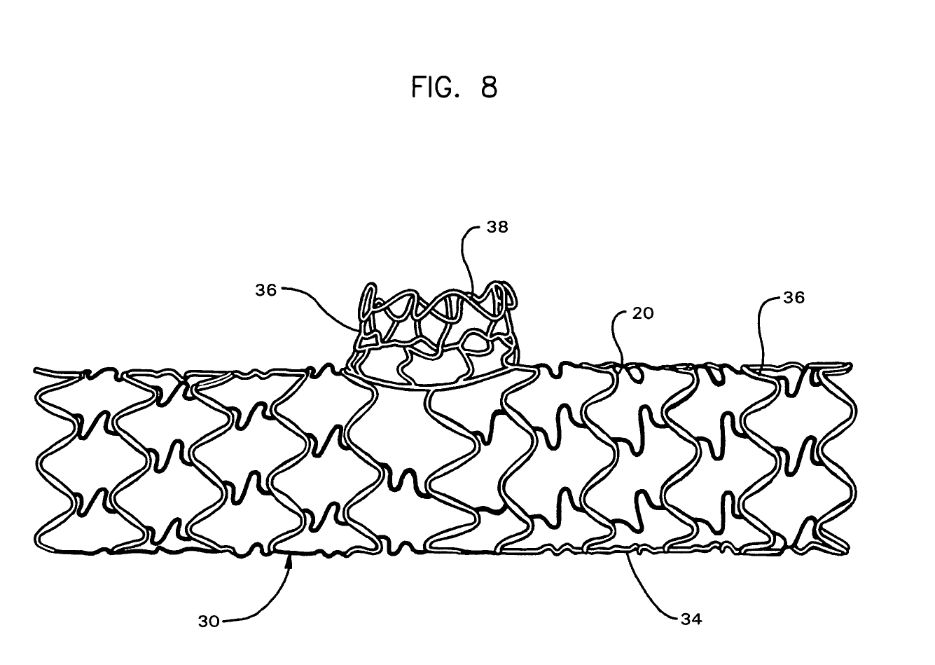

As indicated above, a stent manufactured in accordance with the steps described above may be provided with a variety of characteristics. For example in the embodiment depicted in FIG. 8 a stent 30 is shown wherein a ‘bulged’ region 38 of the stent body 34 is configured to expand to a greater extent than the remainder of the body 34. Such a region 38 is suitable for expansion into an aneurysm or a side-branch opening in a vessel wall. The size and extent of the bulged region 38 can be manipulated by reducing the thickness of the material 20 in the area of the bulged region 38 during deposition of the material 20 during stent formation. In some embodiments the bulged region 38 is provided for by selectively removing or thinning the stent members 36 in or about the area of the bulged region 38. In some embodiments material 20 in the bulged region 38 is more flexible or more easily expanded than the material 20 in adjacent regions of the stent. These and other mechanisms for manipulating the expansion characteristics of the stent 30 and/or specific regions thereof will be recognized and may be utilized alone or in combination.

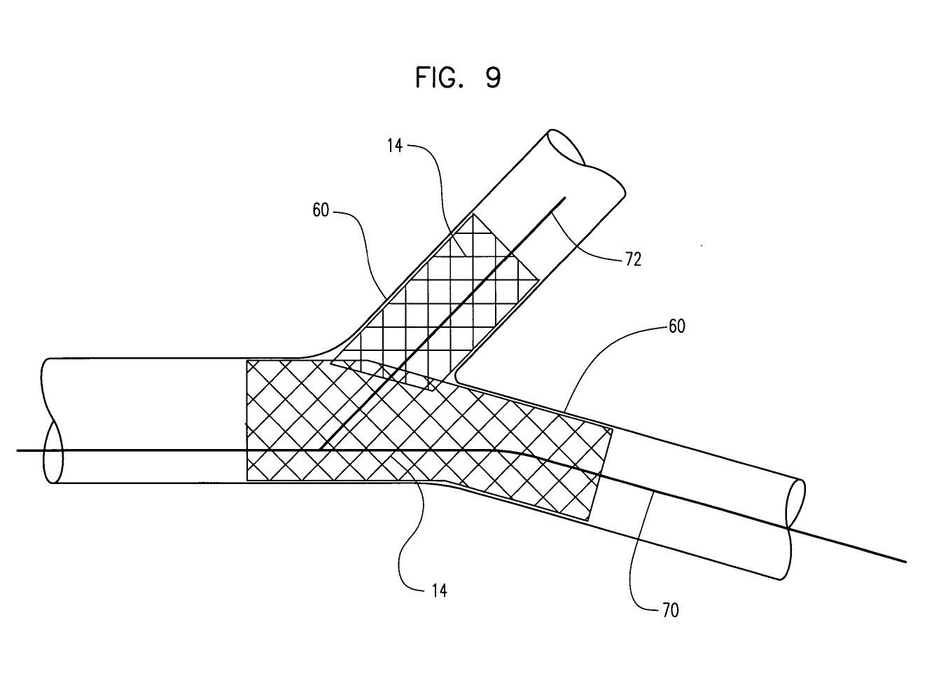

In at least one embodiment, an example of which is shown in FIG. 9, the stent 30 is provided with a side branch opening through which a second sent body 60 may be passed through and/or be engaged thereto. First stent 30 and/or second stent 60 may be manufactured in accordance with the steps described above or may be manufactured by any alternative method or mechanism. In some embodiments, at least one of the stents is constructed at least partially of metal.

In accordance with the manufacturing steps described above, the pattern 14 utilized to form one or both of the stents 30 and 60 may have any configuration desired. As a result any angular orientation between the two stent bodies may be provided for in their construction. For example, in the embodiment shown in FIG. 9 the longitudinal axis 70 of the first stent 30 defines a baseline to which the longitudinal axis 72 of the second stent 60 forms an angle. This angle may be any angle which occurs at a bifurcation of vessels or lumens within mammalian anatomy.

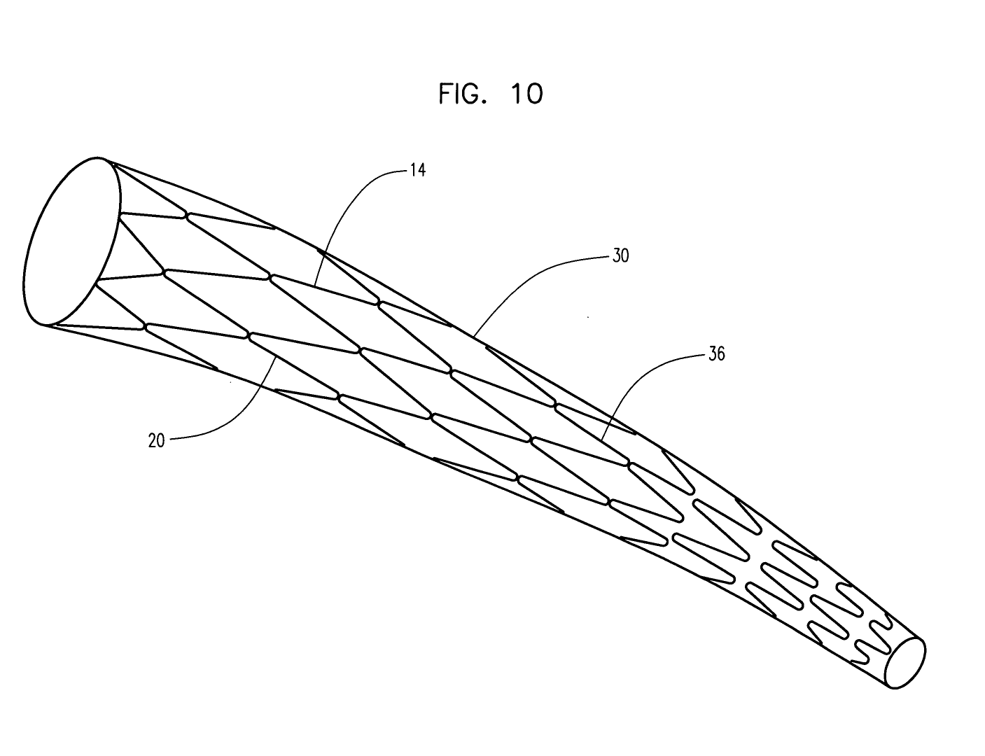

In at least one embodiment, an example of which is shown in FIG. 10, the stent 30 is provided with a configuration such that the stent 30 has a tapered diameter along at least a portion of its length in the expanded state. In at least one embodiment the tapered configuration is provided by selectively thickening the material 20 along the length of the pattern 14 of the template during deposition in order to provide a gradual increase or decrease in resistance to expansion along at least a portion of the length of the stent. Other mechanisms for providing a tapered configuration may also be used, including but not limited to: selective removal of stent members 36 along at least a portion of the length of the stent, selective lengthening and/or shortening of stent member 36 along at least a portion of the length of the stent, etc.

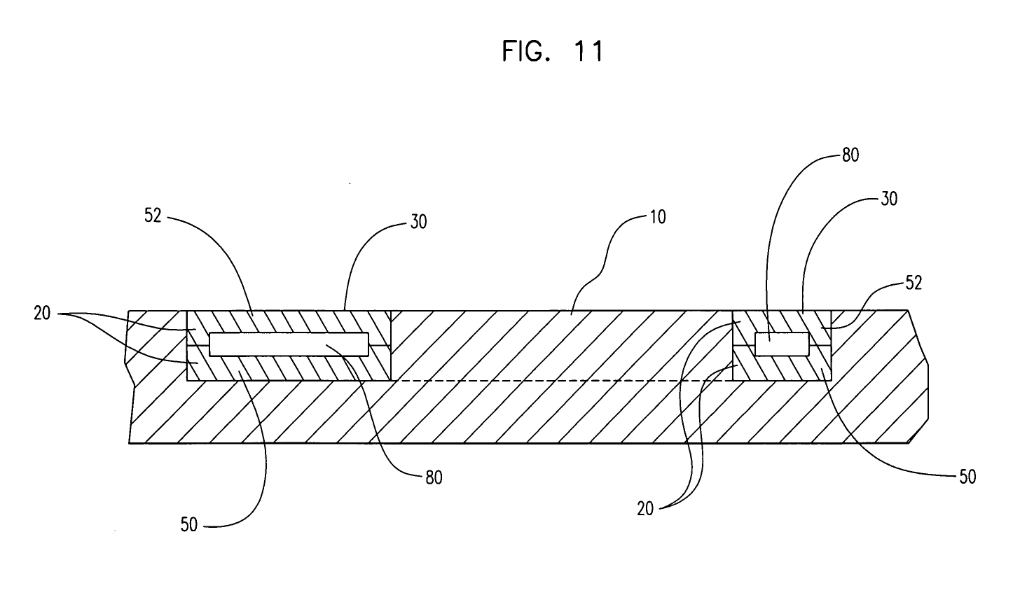

In some embodiments of the invention it is desired to include in the eventual structure of the stent one or more one or more sensors (flow, pressure, etc.), markers (detectable by imaging modalities such as X-Ray, MRI, ultrasound, etc.), marker bands, conductive coils, or other devices or mechanisms collectively referred to hereinafter as “enhancement devices”. In at least one embodiment, an example of which is shown in FIG. 11, one or more enhancement devices 80 is embedded in the material 20 of the stent 30. Such an arrangement may be provided by applying a first layer 50 of material to the template as previously described, followed by the placement of the enhancement device(s) 80 at a desired position on the pattern, followed by a second layer 52 of material to fully encapsulate the enhancement device 80 in the manner shown. In some embodiments enhancement devices may simply be ‘pushed’ into a not yet fully set or cured layer of material to fully or partially embed the enhancement device therein. In some embodiments enhancement devices are engaged to the internal or external surface of the stent following the removal of the template as previously described.

In some embodiments of the invention a therapeutic agent may be incorporated into the material 20 of the stent such as by combining such an agent or agents directly with the material 20, applying such agents in the form of a coating to the material before or after the material has fully cured or set, etc.

A therapeutic agent may be a drug or other pharmaceutical product such as non-genetic agents, genetic agents, cellular material, etc. Some examples of suitable non-genetic therapeutic agents include but are not limited to: anti-thrombogenic agents such as heparin, heparin derivatives, vascular cell growth promoters, growth factor inhibitors, Paclitaxel, etc. Where an agent includes a genetic therapeutic agent, such a genetic agent may include but is not limited to: DNA, RNA and their respective derivatives and/or components; hedgehog proteins, etc. Where a therapeutic agent includes cellular material, the cellular material may include but is not limited to: cells of human origin and/or non-human origin as well as their respective components and/or derivatives thereof. Where the therapeutic agent includes a polymer agent, the polymer agent may be a polystyrene-polyisobutylene-polystyrene triblock copolymer (SIBS), polyethylene oxide, silicone rubber and/or any other suitable substrate.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A process of forming a stent comprising the steps of:
providing a sacrificial template which defines a stent pattern;
applying at least one layer of material over at least a portion of the stent pattern of the sacrificial template; and
eliminating said sacrificial template.

2. The process of claim 1 wherein the stent pattern is defined by a plurality of interconnected indentations defined by the sacrificial template.

3. The process of claim 2 further comprising the step of:
positioning at least one fiber into at least one of the indentations.

4. The process of claim 3 wherein the at least one fiber is positioned into the at least one of the indentations after application of the at least one material.

5. The process of claim 3 wherein the at least one fiber is positioned into the at least one of the indentations before application of the at least one material.

6. The process of claim 1 wherein the at least one layer of material comprises a polymeric composition and said material fills the plurality of indentations.

7. The process of claim 2 wherein the at least one fiber is braided, woven, knitted, roving, or wound.

8. The process of claim 2 wherein the at least one fiber comprises a plurality of fibers, the plurality of fibers being arranged randomly, in the form of a braided, inter-woven, or wound.

9. The process of claim 1 wherein the at least one layer of material comprises a plurality of distinct layers of material, each layer being applied over the sacrificial template separately from one another.

10. The process of claim 11 wherein said sacrificial template comprises a water dispersible or water soluble polymer.

11. The process of claim 10 wherein said polymer is selected from the group consisting of polyvinyl alcohol, polyvinyl acetate or mixtures thereof.

12. The process of claim 11 wherein the sacrificial template is eliminated by the step of flushing said sacrificial structure with water at a temperature of about 25° C. to about 110° C.

13. The process of claim 1 wherein the at least one layer of material comprises at least one thermoplastic polymer.

14. The process of claim 13 wherein said thermoplastic polymer is selected from the group consisting of polyesters, polyamides, polyolefins, polyurethanes, polyethers, polyimides, any copolymers thereof, styrenic block copolymers and mixtures thereof.

15. The process of claim 13 wherein said thermoplastic polymer is selected from the group consisting of poly(ester block ester), poly(ester block ether), poly(ether block amide), polyalkylene terephthalate or mixture thereof.

16. The process of claim 2 further comprising the step of:
positioning at least enhancement device into at least one of the indentations, the at least one enhancement device being at least one device selected from the group consisting of: sensors, detectable markers, marker bands, conductive coils, and any combination thereof.

17. The process of claim 2 wherein following the elimination of the sacrificial template an expandable stent is provided from the at least one layer of material, the stent comprising a stent body constructed of a plurality of interconnected stent members which correspond to the shape and arrangement of the plurality of interconnected indentations.

18. The process of claim 17 further comprising the step of removing at least one of the a plurality of interconnected stent members from the stent body.

19. The process of claim 17 wherein at least a portion of the stent body has a tapering diameter when the stent is placed in an expanded state.

20. The process of claim 17 wherein the body defines a flow path therethrough, adjacent interconnected stent members define a side branch opening through the stent body, the side branch opening being in fluid communication with the flow path.

21. The process of claim 1 wherein the stent pattern is defined by a plurality of channels defined by the sacrificial template.

22. A template for forming a stent, the template comprising a sacrificial material.

23. The template of claim 22 defining a negative stent pattern, the negative stent patter comprising a plurality of interconnected indentations.
